(19) United States
(12) Patent Application Publication
(10) Pub. No.: US 2013/0007800 A1
(43) Pub. Date: Jan. 3, 2013

(54) SYSTEM AND METHOD FOR RENDERING MESSAGING CONTENT WHILE CONTEMPORANEOUSLY RENDERING MULTIMEDIA CONTENT

(75) Inventor: Eskil Ahlin, Veberod (SE)

(73) Assignee: SONY ERICSSON MOBILE COMMUNICATIONS AB, Lund (SE)

(21) Appl. No.: 13/393,231

(22) PCT Filed: Mar. 31, 2011
(86) PCT No.: PCT/IB2011/000700

§ 371 Date: Aug. 20, 2012

(51) Int. Cl. H04N 21/23

(52) U.S. Cl. 725/32

(57) ABSTRACT

A system and method for directed to automatically synchronizing the rendering of messaging content with multimedia content. The method includes: receiving multimedia content from a source, wherein the multimedia content is transmitted in a data stream; outputting the multimedia content to an associated rendering device; processing the multimedia content to synchronize messaging content to be displayed on the rendering device contemporaneously with the multimedia content, wherein processing includes determining a reduction in data transmitted in the data stream; and displaying the messaging content on the associated rendering device.

### TECHNICAL FIELD OF THE INVENTION

The present invention relates generally to analysis of multimedia content and determining an appropriate time to render messaging content contemporaneously with the multimedia content.

### DESCRIPTION OF THE RELATED ART

It is a common practice by multimedia content providers and/or network broadcasters to use tickers or banners to promote an upcoming event, movie or series. Such tickers or banners are commonly displayed without regard to what is occurring in the multimedia content being contemporaneously rendered.

### SUMMARY

It has been discovered that for messaging content that is rendered on tickers or banners to be effective, the messaging content should be synchronized with the multimedia content being rendered. For example, the must messaging content should be shown (or rendered) when the multimedia content is experiencing a lull or down time in activity and/or sound. Because it may be costly to manually synchronize the messaging content, one aspect of the invention is directed to automatically synchronizing the rendering of the messaging content when the multimedia content is being rendered. Thus, there is a need in the art for a system and method to automatically synchronize the messaging content while multimedia content is being rendered concurrently.

One aspect of the invention relates to a computer implemented method to coordinate multimedia content with messaging content, the method including: receiving multimedia content from a source, wherein the multimedia content is transmitted in a data stream; outputting the multimedia content to an associated rendering device; processing the multimedia content to synchronize messaging content to be displayed on the rendering device contemporaneously with the multimedia content, wherein processing includes determining a reduction in data transmitted in the data stream; and displaying the messaging content on the associated rendering device.

Another aspect of the invention relates to the messaging content being displayed in a banner under the multimedia content rendered on the associated rendering device.

Another aspect of the invention relates to the messaging content being displayed in a banner over a portion the multimedia content rendered on the associated rendering device.

Another aspect of the invention relates to the data being compared to a threshold value, such that when the data transmitted falls below the threshold value, the messaging content is displayed on the on the associated rendering device.

Another aspect of the invention relates to the reduction in data being compared to a threshold value, such that when the data transmitted falls below the threshold value, the messaging content is displayed on the on the associated rendering device.

Another aspect of the invention relates to the reduction in data being determined based on processing metadata embedded in the multimedia content.

Another aspect of the invention relates to the reduction in data being determined based on determining a bit rate associated with the stream of multimedia content.

Another aspect of the invention relates to the messaging data being stored locally by a device coupled to the rendering device.

Another aspect of the invention relates to the messaging content being stored at a remote server.

One aspect of the invention relates to an electronic device including: a memory for receiving multimedia content from a source, wherein the multimedia content is transmitted in a data stream; a controller coupled to the memory, wherein the controller processes the multimedia content to synchronize messaging content to be displayed on a rendering device contemporaneously with the multimedia content, wherein processing includes determining a reduction in data transmitted in the data stream; and a display coupled to the controller, wherein the display is operable to present the messaging content and the multimedia content.

Another aspect of the invention relates to the display presenting the messaging content in a banner under the multimedia content rendered on the display.

Another aspect of the invention relates to the display presenting the messaging content in a banner over a portion the multimedia content rendered on the display.

Another aspect of the invention relates to the reduction in data being compared to a threshold value, such that when the data transmitted falls below the threshold value, the messaging content is presented on the display.

Another aspect of the invention relates to the reduction in data being determined based on processing metadata embedded in the multimedia content.

Another aspect of the invention relates to the reduction in data being determined based on determining a bit rate associated with the stream of multimedia content.

Another aspect of the invention relates to the memory being configured to store messaging data to be displayed on the display.

Another aspect of the invention relates to the electronic device being a mobile telephone.

Another aspect of the invention relates to the electronic device being a television.

Another aspect of the invention relates to the electronic device being a computer.

One aspect of the invention relates to a computer program stored on a non-transitory machine usable medium in a memory, the program being suitable for use in an electronic device for coordinating multimedia content with messaging content, wherein when the program is loaded in the memory and executed causes the electronic device to: receive multimedia content from a source, wherein the multimedia content is transmitted in a data stream; output the multimedia content to an associated rendering device; process the multimedia content to synchronize messaging content to be displayed on the rendering device contemporaneously with the multimedia content, wherein processing includes determining a reduction in data transmitted in the data stream; and display the messaging content on the associated rendering device.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments. It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is an exemplary system in accordance with aspect of the present invention.

FIG. 2 is a schematic view of a portable communication in accordance with an embodiment of the present invention.

FIG. 3 is a schematic block diagram of the relevant portion of the portable communication device of FIG. 2 in accordance with an embodiment of the present invention.

FIG. 4 is another exemplary system in accordance with aspects of the present invention.

FIG. 5 is a flow chart of an exemplary method in accordance with embodiments of the present invention.

FIG. 6 is an exemplary system illustrating a use case in accordance with aspects of the present invention.

FIG. 7 is another exemplary system in accordance with another embodiment of the present invention.

### DETAILED DESCRIPTION OF EMBODIMENTS

The present invention will now be described with reference to the drawings, wherein like reference numerals are used to refer to like elements throughout. It will be understood that the figures are not necessarily to scale.

The term “electronic device” refers to any type of electronic device that is operable to perform all and/or one or more portions of the functionality described herein. For example, the phrase “electronic device” may be used herein to refer to a mobile telephone, portable communication device, computer, computing device, sensor, portable radio communication equipment, television, tablet computer, pager, personal digital assistant (PDA), portable communication device, set top cable or satellite box coupled to a display, audio and/or video playback devices (e.g., MP3 players, DVD players, etc.), etc.

Referring initially to FIG. 1, an electronic device 10 is shown in accordance with the present invention. The electronic device includes a messaging synchronization function that is configured to analyze multimedia content received in a data stream by the electronic device 10 and output messaging content at an appropriate time, as discussed below.

As used herein, the phrase “multimedia content” should be interpreted broadly to include audio content, video content, or any other content that is to be viewed, read and/or heard by one or more users of the electronic device. The phrase “messaging content” should be interpreted broadly to include any text, symbols, graphics, or combinations thereof, which may be used to convey information to an individual or group of individuals viewing and/or listening to the electronic device and/or rendering device.

It will be appreciated that the messaging synchronization function may be embodied as executable code that may be resident in the electronic device 10 and/or reside in a separate electronic device that is coupled to the electronic device 10. For example, the separate electronic device may be a set top box for receiving cable signals and/or satellite television signals, an audio playback device and/or a DVD player.

The electronic device 10 may be configured to receive conventional streamed multimedia content in the form commonly transmitted by cable television providers, satellite television providers, Internet servers and the like. In addition, the electronic device 10 may include mobile television and/or mobile radio capability. For example, mobile items of electronic devices may be able to receive and render video content, along with outputting associated audio content. For instance, such electronic equipment may be compatible with the Digital Video Broadcasting-Handheld (DVB-H) standard for bringing broadcast services to handheld receivers.

DVB-H, which falls within the set of DVB transmission standards, adapts the DVB-T system for digital terrestrial television for use with handheld, battery-powered devices. DVB-H can offer a downstream channel at high data rates for use by standalone devices or as an enhancement to mobile telecommunications networks. As will be appreciated, mobile telecommunications networks are traditionally used to provide services such as telephone communications, messaging and/or Internet access to various items of electronic equipment.

DVB-H employs time slicing technology to reduce power consumption by the receiving device. Time slicing under DVB-H involves transmitting IP datagrams as data bursts in time slots. The front end of a DVB-H compatible receiver switches on only for the time interval when the data burst of a selected service is on air. When watching television, for example, the selected service may correspond to the channel or program that the user wishes to watch. Within the short period of time corresponding to the time slots for the selected service, data is received. The data may be stored in a buffer and then passed to a decoder for generation of a video signal that may, in turn, be used to drive a display for presentation of video content to a user. There are often about ten or more bursted services in a DVB-H stream and the receiver is synchronized to receive and buffer a user selected one of the services. By ignoring the remaining services, the receiving device may save considerable battery resources. The term IP datacast is used to refer to the technical elements to create DVB-H based services and those that are used to integrate DVB-H in a hybrid network structure having both a mobile communications network such as general packet radio service (GPRS) or universal mobile telephone service (UMTS) and an additional DVB-H downstream.

While the above description describes DVB-H transmission, aspects of the present invention are directed to any electronic device that is operable to receive any type of multimedia content in any format (e.g., hand-held devices that receive DVB-H compatible signals, electronic devices that receive cable television signals, and/or satellite signals; multimedia content streamed from remote servers (e.g., Netflix, Amazon, YouTube, etc.).

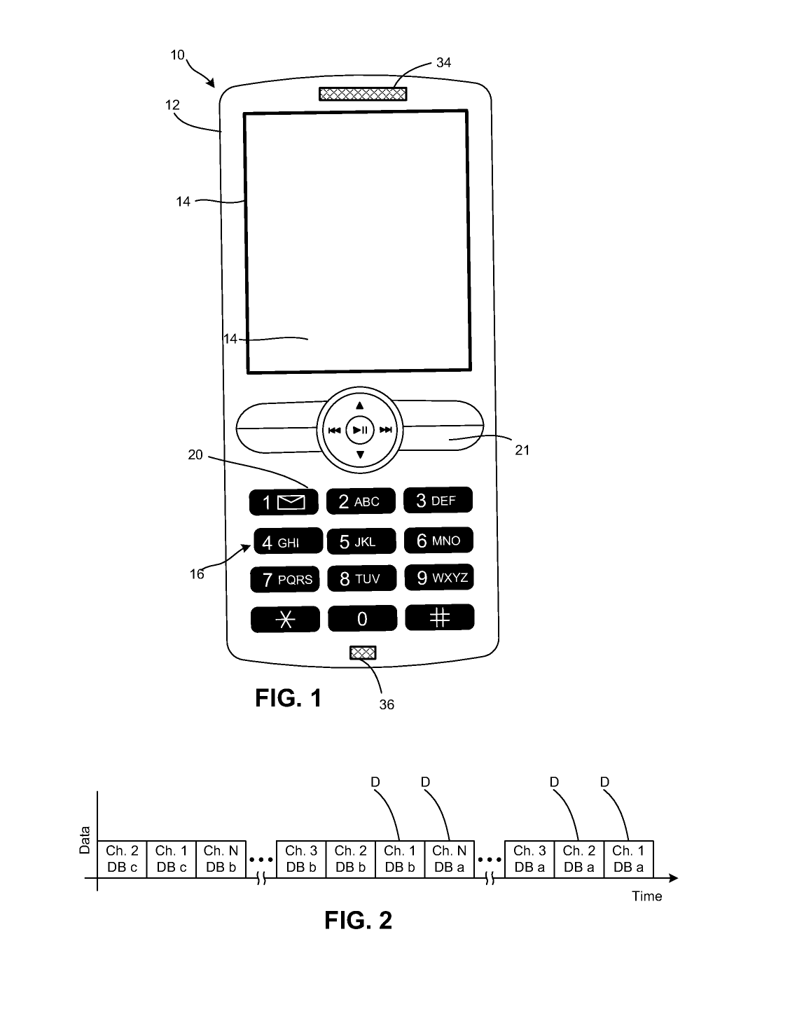

With additional reference to FIG. 2, an exemplary series of time sliced data bursts D for plural channels is illustrated. In the data transmission sequence, a first data burst (DB a) for a first channel (Ch. 1) is followed by a first data burst (DB a) for a second channel (Ch. 2), which is followed by a first data burst (DB a) for a third channel (Ch. 3). The string of first data bursts (DB a) continues until the last channel (Ch. N) is reached, after which a second data burst (DB b) for each channel is sequentially transmitted and then a third data burst (DB c) for each channel is sequentially transmitted, and so on.

A receiver of the electronic equipment 10 is tuned to the appropriate channel by tuning the receiver to the selected channel. The receiver is configured to be synchronized to the data bursts of the selected channel. The data bursts for the selected channel are received by the receiver and decoded so that a displayable video signal and associated audio signal are generated, but the remaining data bursts are ignored. To generate the video and audio signals, the data bursts for the selected channel are assembled to effectively bridge the time elapsing between data bursts for the selected channel and during which data bursts for other channels are transmitted.

In another embodiment, the multimedia content is streamed over a cable medium to electronic device or transmitted through a satellite. For purposes of this application, any multimedia content transmitted from a source is considered to be transmitted in a data stream. For example, DVB-H communications, communications over a cable medium, communications from a satellite, communications from a local server or a remote server; and wireless communications containing multimedia content are considered to be transmitted in a data stream, regardless of the term used to describe such communications in their respective technical standards.

In the description herein, the transmitted and processed data is multimedia content. As stated above, multimedia includes audio content, video content, or any other content that is to be viewed, read and/or heard by one or more users of the electronic device. It will be understood that the multimedia content may be encoded in any format and that the processing of the multimedia content is operable to decode the format received.

With reference back to FIG. 1, the illustrated electronic device 10 may be a portable, battery powered device. The electronic device 10 in the exemplary embodiment is a mobile telephone and will be referred to as the mobile telephone 10. The mobile telephone 10 is shown as having a “brick” or “block” design type housing 12, but it will be appreciated that other type housings, such as a clamshell housing or a slide-type housing, may be utilized without departing from the scope of the invention.

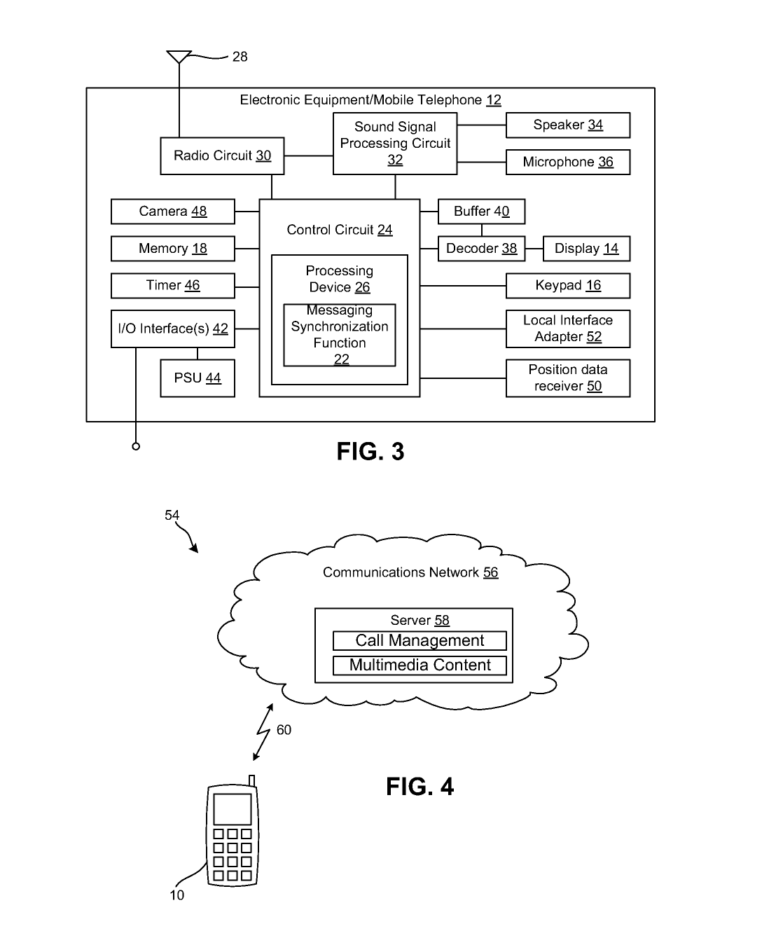

The mobile telephone 10 includes a display 14 and keypad 16. As is conventional, the display 14 displays information to a user such as operating state, time, telephone numbers, contact information, various navigational menus, etc., which enable the user to utilize the various feature of the mobile telephone 10. The display 14 may also be used to visually display multimedia content received by the mobile telephone 10 and/or retrieved from a memory 18 (FIG. 3) of the mobile telephone 10.

Similarly, the keypad 16 may be conventional in that it provides for a variety of user input operations. For example, the keypad 16 typically includes alphanumeric keys 20 for allowing entry of alphanumeric information such as telephone numbers, phone lists, contact information, notes, etc. In addition, the keypad 16 typically includes special function keys such as a “call send” key for initiating or answering a call, and a “call end” key for ending, or “hanging up” a call. Special function keys may also include menu navigation keys, for example, for navigating through a menu displayed on the display 14 to select different telephone functions, profiles, settings, etc., as is conventional. Other keys associated with the mobile telephone may include a volume key, audio mute key, an on/off power key, a web browser launch key, a camera key, etc. Keys or key-like functionality may also be embodied as a touch screen associated with the display 14.

The mobile telephone 10 includes conventional call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc.

FIG. 3 represents a functional block diagram of the mobile telephone 10. With the exception of a messaging synchronization function 22 according to the present invention, which is preferably implemented as executable logic in the form of application software or code within the mobile telephone 10, the construction of the mobile telephone 10 is otherwise generally conventional.

The mobile telephone 10 includes a primary control circuit 24 that is configured to carry out overall control of the functions and operations of the mobile telephone 10. The control circuit 24 may include a processing device 26, such as a CPU, microcontroller or microprocessor. The processing device 26 executes code stored in a memory (not shown) within the control circuit 24 and/or in a separate memory, such as memory 18, in order to carry out conventional operation of the mobile telephone 10. The memory 18 may be, for example, one or more of a buffer, a flash memory, a hard drive, a removable media, a volatile memory, a non-volatile memory or other suitable device. In addition, the processing device 26 executes code in accordance with the present invention in order to perform the messaging synchronization function 22.

It will be apparent to a person having ordinary skill in the art of computer programming, and specifically in applications programming for mobile telephones or other items of electronic devices, how to program a mobile telephone 10 to operate and carry out the functions described herein. Accordingly, details as to the specific programming code have been left out for sake of brevity. Also, while the messaging synchronization function 22 is executed by the processing device 26 in accordance with the preferred embodiment of the invention, such functionality could also be carried out via dedicated hardware, firmware, software, or combinations thereof, without departing from the scope of the invention.

Continuing to refer to FIGS. 1 through 3, the mobile telephone 10 includes an antenna 28 coupled to a radio circuit 30. The radio circuit 30 includes a radio frequency transmitter and receiver for transmitting and receiving signals via the antenna 28 as is conventional. The radio circuit 30 may be configured to operate in a mobile communications network, as well as to receive multimedia content transmitted in a data stream. For example, the receiver may be an IP datacast compatible receiver compatible with a hybrid network structure providing mobile communications and DVB-H based or similar services. For other electronic devices, it will be assumed that the receiver is compatible with the format of the multimedia content expected to be received.

The mobile telephone 10 further includes a sound signal processing circuit 32 for processing the audio signal transmitted by/received from the radio circuit 30. Coupled to the sound processing circuit 32 are a speaker 34 and a microphone 36 that enable a user to listen and speak via the mobile telephone 10 as is conventional. The speaker 34 also enables audible signals associated with received multimedia content to be output to the user. The radio circuit 30 and sound processing circuit 32 are each coupled to the control circuit 24 so as to carry out overall operation.

The mobile telephone 10 also includes the aforementioned display 14 and keypad 16 coupled to the control circuit 24. The display 14 may be coupled to the control circuit 24 by a video decoder 38 that converts video data to a video signal used to drive the display 14. The video data may be retrieved from a video file that is stored in the memory 18 or from received multimedia content. Prior to being feed to the decoder 38, the multimedia content may be buffered in a buffer 40.

The mobile telephone 10 further includes one or more I/O interface(s) 42. The I/O interface(s) 42 may be in the form of typical mobile telephone I/O interfaces and may include one or more electrical connectors. As is typical, the I/O interface(s) 42 may be used to couple the mobile telephone 10 to a battery charger to charge a battery of a power supply unit (PSU) 44 within the mobile telephone 10. In addition, or in the alternative, the I/O interface(s) 42 may serve to connect the mobile telephone 10 to a wired personal hands-free adaptor (not shown). Further, the I/O interface(s) 42 may serve to connect the mobile telephone 10 to a personal computer or other device via a data cable or wireless link, etc. The mobile telephone 10 may receive operating power via the I/O interface(s) 42 when connected to a vehicle power adapter or an electricity outlet power adapter.

The mobile telephone 10 may also include a timer 46 for carrying out timing functions. Such functions may include, for example, timing the durations of calls, generating the content of time and date stamps, timing the duration multimedia content is viewed, etc.

The mobile telephone 10 may include a camera 48 for taking digital pictures and/or movies. Image and/or video files corresponding to the pictures and/or movies may be stored in the memory 18. The mobile telephone 10 also may include a position data receiver 50, such as a global positioning satellite (GPS) receiver, Galileo satellite system receiver or the like. The mobile telephone 10 also may include a local wireless interface 52, such as a Bluetooth adaptor, for establishing communication with an accessory, hands-free adaptor, computer or other device.

As indicated, the mobile telephone 10 may be configured to operate in a communications network 56, as illustrated in FIG. 4. The system 56 can include a one or more servers 58 or servers for managing calls placed by and destined to the mobile telephone 10, transmitting data to the mobile telephone 10 and carrying out any other support functions. The one or more servers may also contain multimedia content to be transmitted in a data from the server to the mobile telephone 10. The server communicates with the mobile telephone 10 via a network 56 and a transmission medium 60. The transmission medium may be any appropriate device or assembly, including, for example, a communications tower, another mobile telephone, a wireless access point, a satellite, etc. Portions of the network may include wireless transmission pathways and/or wired transmission pathways.

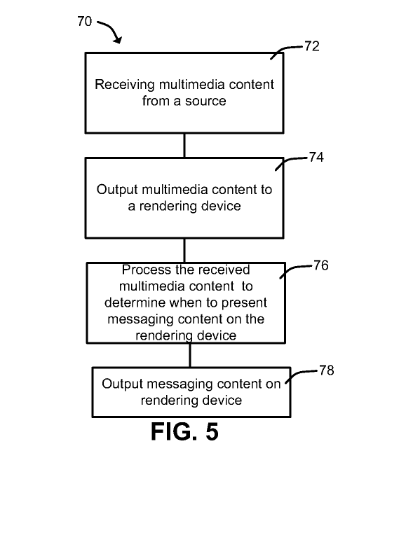

Referring to FIG. 5, a computer implemented method 70 to coordinate multimedia content with messaging content is illustrated. The method 70 includes at block 72, receiving multimedia content from a source, wherein the multimedia content is transmitted in a data stream. The multimedia content can be any type of content that is transmitted from a source to the electronic device 10. Likewise, the source of multimedia content may be local (e.g., from multimedia content stored in memory 18) and/or remote (e.g., from server 58 and/or an external hard drive or the like).

At block 74, the multimedia content is output to an associated rendering device. The rendering device may be a component of the electronic device 10 or a separate electronic device. For example, if the electronic device 10 includes a display 14, the rendering device may be the display 14. If the electronic device 10 is a set top box, for example, the rendering device may be a display and/or a television coupled to the electronic device 10.

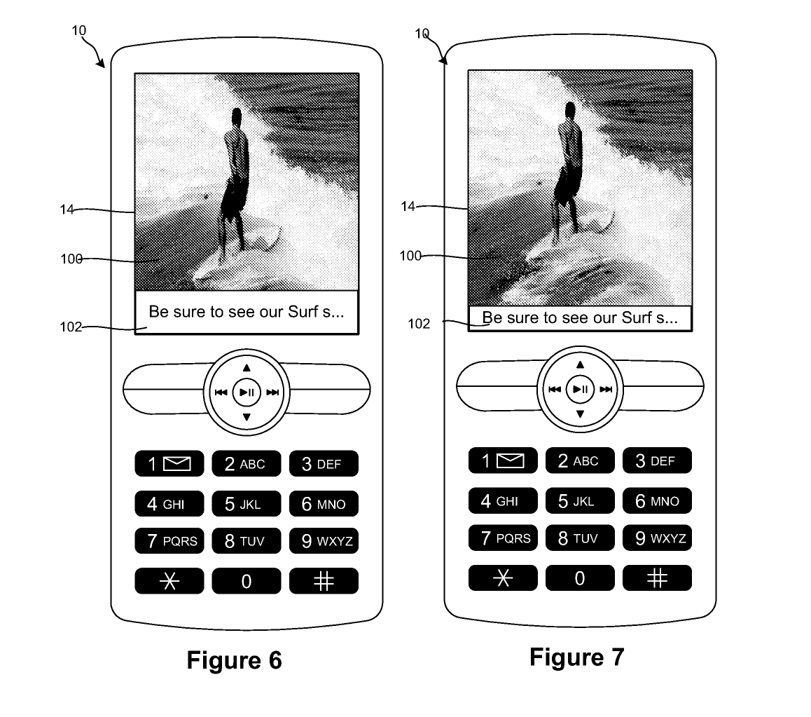

At block 76, the multimedia content received by the electronic device 10 is processed to synchronize messaging content to be displayed on the rendering device contemporaneously with the multimedia content. As used herein, the “messaging content” is distinct from the multimedia content received and rendered by the electronic device. Messaging content as used in the present invention is indicative of information that may be displayed in a ticker and/or banner in a portion of the display 14 contemporaneously with the multimedia content. For example, referring to FIG. 6, a display 14 is illustrated with multimedia content 100 being displayed on a majority of the display and messaging content 102 being displayed on a much smaller portion of the display 14. For example, the messaging content 102 may scroll across the bottom of the screen to provide information to the viewer of the multimedia content.

Messaging content may include any type of information that is germane to the multimedia content being viewed by the user, to the channel being viewed, to the operator providing the content, the intended audience, etc. In addition, the messaging content may include advertisements or emergency messages directed to viewers of the multimedia content, for example. The messaging content may be displayed in any desired manner. For example, in one embodiment, the messaging content may be displayed in a banner over a portion the multimedia content rendered on the associated rendering device, as shown in FIG. 6. In another embodiment, the messaging content is displayed in a banner under the multimedia content rendered on the associated rendering device, as shown in FIG. 7. In FIGS. 6 and 7, the messaging content may read, for example, “Be sure to see our Surf special coming up after this program.”

For the messaging content to be effective, e.g., for the user to notice the messaging content, the messaging should be synchronized with the multimedia content so that the messaging content is displayed when the multimedia content has little (or less) action occurring and/or a lower sound level. One aspect of the invention is to automatically synchronize the messaging content with the multimedia content rendered on the rendering device in order to avoid manual synchronization, which can be expensive and time consuming.

At block 76, the processor generally determines when there is a reduction in received in the data stream associated with the multimedia content from the source to the electronic device 10 (e.g., the process may determine a reduction in data transmitted in the data stream). The processor may make this calculation in any desired manner. For example, the processor may determine the reduction in data by comparing the recently received data stream with a threshold value, such that when the data transmitted falls below the threshold value, the messaging content is displayed on the associated rendering device, as set forth in block 78. In another embodiment, the processor may determine a reduction in data that is determined based on processing metadata embedded in the multimedia content. If the processed metadata indicates a reduction in received data or signals to the display the messaging content, the messaging content is displayed on the associated rendering device, as set forth in block 78. In yet another embodiment, the reduction in data may be determined based on determining a bit rate associated with the stream of multimedia content. If the bit rate is below a previous bit rate or a predetermined bit or a user configured bit rate, for example, the messaging content may displayed on the associated rendering device, as set forth in block 78. One of ordinary skill in the art will readily appreciate that there are a number of ways to determine when a lull in the multimedia content is occurring and each of those ways is considered to fall within the scope of the present invention.

The messaging content may be stored locally in the memory 18 of the electronic device 10 or a device coupled to the rendering device. In another embodiment, the messaging content may be stored at a remote server 58, for example.

Although the illustrated method shows a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores, or messages may be added to the logical flow for purposes of enhanced utility, accounting, performance, measurement, troubleshooting, and the like. It is understood that all such variations are within the scope of the present invention.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

1. A computer implemented method to coordinate multimedia content with messaging content, the method comprising:
receiving multimedia content from a source, wherein the multimedia content is transmitted in a data stream;
outputting the multimedia content to an associated rendering device;
processing the multimedia content to synchronize messaging content to be displayed on the rendering device contemporaneously with the multimedia content, wherein processing includes determining a reduction in data transmitted in the data stream; and
displaying the messaging content on the associated rendering device.

2. The method of claim 1, wherein the messaging content is displayed in a banner under the multimedia content rendered on the associated rendering device.

3. The method of claim 1, wherein the messaging content is displayed in a banner over a portion the multimedia content rendered on the associated rendering device.

4. The method of claim 1, wherein the reduction in data is compared to a threshold value, such that when the data transmitted falls below the threshold value, the messaging content is displayed on the associated rendering device.

5. The method of claim 1, wherein the reduction in data is compared to a threshold value, such that when the data transmitted falls below the threshold value, the messaging content is displayed on the on the associated rendering device.

6. The method of claim 1, wherein the reduction in data is determined based on processing metadata embedded in the multimedia content.

7. The method of claim 1, wherein the reduction in data is determined based on determining a bit rate associated with the stream of multimedia content.

8. The method of claim 1, wherein the messaging data is stored locally by a device coupled to the rendering device.

9. The method of claim 1 wherein the messaging content is stored at a remote server.

10. An electronic device comprising:
a memory for receiving multimedia content from a source, wherein the multimedia content is transmitted in a data stream;
a controller coupled to the memory, wherein the controller processes the multimedia content to synchronize messaging content to be displayed on a rendering device contemporaneously with the multimedia content, wherein processing includes determining a reduction in data transmitted in the data stream; and
a display coupled to the controller, wherein the display is operable to present the messaging content and the multimedia content.

11. The electronic device of claim 10, wherein the display presents the messaging content in a banner under the multimedia content rendered on the display.

12. The electronic device of claim 10, wherein the display presents the messaging content in a banner over a portion the multimedia content rendered on the display.

13. The electronic device of claim 10, wherein the reduction in data is compared to a threshold value, such that when the data transmitted falls below the threshold value, the messaging content is presented on the display.

14. The electronic device of claim 10, wherein the reduction in data is determined based on processing metadata embedded in the multimedia content.

15. The electronic device of claim 10, wherein the reduction in data is determined based on determining a bit rate associated with the stream of multimedia content.

16. The electronic device of claim 10, wherein the memory is configured to store messaging data to be displayed on the display.

17. The electronic device of claim 10, wherein the electronic device is a mobile telephone.

18. The electronic device of claim 10 wherein the electronic device is a television.

19. The electronic device of claim 10, wherein the electronic device is a computer.

20. A computer program stored on a non-transitory machine usable medium in a memory, the program being suitable for use in an electronic device for coordinating multimedia content with messaging content, wherein when the program is loaded in the memory and executed causes the electronic device to: receive multimedia content from a source, wherein the multimedia content is transmitted in a data stream; output the multimedia content to an associated rendering device; process the multimedia content to synchronize messaging content to be displayed on the rendering device contemporaneously with the multimedia content, wherein processing includes determining a reduction in data transmitted in the data stream; and display the messaging content on the associated rendering device.
